(19) United States
(12) Patent Application Publication
(10) Pub. No.: US 2011/0149040 A1
(43) Pub. Date: Jun. 23, 2011

(54) METHOD AND SYSTEM FOR INTERLACING 3D VIDEO

(76) Inventors: Ilya Klebanov, Thornhill (CA); Xuemin Chen, Rancho Santa Fe, CA (US); Samir Hulyalkar, Newtown, PA (US); Marcus Kellerman, San Diego, CA (US)

(21) Appl. No.: 12/698,776

(22) Filed: Feb. 2, 2010

Related U.S. Application Data
(60) Provisional application No. 61/287,668, filed on Dec. 17, 2009.

(51) Int. Cl. H04N 13/02

(52) U.S. Cl. 348/46; 348/441; 348/E13.074

(57) ABSTRACT

A video processing device may generate and/or capture a plurality of view sequences of video frames, decimate at least some of the plurality of view sequences, and may generating a three-dimension (3D) video stream comprising the plurality of view sequences based on that decimation. The decimation may be achieved by converting one or more of the plurality of view sequences from progressive to interlaced video. The interlacing may be performed by removing top or bottom fields in each frame of those one or more view sequences during the conversion to interlaced video. The removed fields may be selected based on corresponding conversion to interlaced video of one or more corresponding view sequences. The video processing device may determine bandwidth limitations existing during direct and/or indirect transfer or communication of the generated 3D video stream. The decimation may be performed based on this determination of bandwidth limitations.

### CROSS-REFERENCE TO RELATED APPLICATIONS/INCORPORATION BY REFERENCE

This patent application makes reference to, claims priority to and claims benefit from U.S. Provisional Application Ser. No. 61/287,668 which was filed on Dec. 17, 2009.

This application also makes reference to:

U.S. Provisional Application Ser. No. 61/287,624 which was filed on Dec. 17, 2009;
U.S. Provisional Application Ser. No. 61/287,634 which was filed on Dec. 17, 2009;
U.S. application Ser. No. 12/554,416 which was filed on Sep. 4, 2009;
U.S. application Ser. No. 12/546,644 which was filed on Aug. 24, 2009;
U.S. application Ser. No. 12/619,461 which was filed on Nov. 6, 2009;
U.S. application Ser. No. 12/578,048 which was filed on Oct. 13, 2009;
U.S. Provisional Application Ser. No. 61/287,653 which was filed on Dec. 17, 2009;
U.S. application Ser. No. 12/604,980 which was filed on Oct. 23, 2009;
U.S. application Ser. No. 12/545,679 which was filed on Aug. 21, 2009;
U.S. application Ser. No. 12/560,554 which was filed on Sep. 16, 2009;
U.S. application Ser. No. 12/560,578 which was filed on Sep. 16, 2009;
U.S. application Ser. No. 12/560,592 which was filed on Sep. 16, 2009;
U.S. application Ser. No. 12/604,936 which was filed on Oct. 23, 2009;
U.S. application Ser. No. 12/573,746 which was filed on Oct. 5, 2009;
U.S. application Ser. No. 12/573,771 which was filed on Oct. 5, 2009;
U.S. Provisional Application Ser. No. 61/287,673 which was filed on Dec. 17, 2009;
U.S. Provisional Application Ser. No. 61/287,682 which was filed on Dec. 17, 2009;
U.S. application Ser. No. 12/605,039 which was filed on Oct. 23, 2009;
U.S. Provisional Application Ser. No. 61/287,689 which was filed on Dec. 17, 2009; and
U.S. Provisional Application Ser. No. 61/287,692 which was filed on Dec. 17, 2009.

Each of the above stated applications is hereby incorporated by reference in its entirety.

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to video processing. More specifically, certain embodiments of the invention relate to a method and system for interlacing 3D video.

### BACKGROUND OF THE INVENTION

Display devices, such as television sets (TVs), may be utilized to output or playback audiovisual or multimedia streams, which may comprise TV broadcasts, telecasts and/or localized audio-visual (AV) feeds from one or more available consumer devices, such as videocassette recorders (VCRs) and/or Digital Video Disc (DVD) players. TV broadcasts and/or audiovisual or multimedia feeds may be inputted directly into the TVs, or it may be passed intermediately via one or more specialized set-top boxes that may enable providing any necessary processing operations. Exemplary types of connectors that may be used to input data into TVs include, but not limited to, F-connectors, S-video, composite and/or video component connectors, and/or, more recently, High-Definition Multimedia Interface (HDMI) connectors.

Television broadcasts are generally transmitted by television head-ends over broadcast channels, via RF carriers or wired connections. TV head-ends may comprise terrestrial TV head-ends, Cable-Television (CATV), satellite TV head-ends and/or broadband television head-ends. Terrestrial TV head-ends may utilize, for example, a set of terrestrial broadcast channels, which in the U.S. may comprise, for example, channels 2 through 69. Cable-Television (CATV) broadcasts may utilize even greater number of broadcast channels. TV broadcasts comprise transmission of video and/or audio information, wherein the video and/or audio information may be encoded into the broadcast channels via one of plurality of available modulation schemes. TV Broadcasts may utilize analog and/or digital modulation format. In analog television systems, picture and sound information are encoded into, and transmitted via analog signals, wherein the video/audio information may be conveyed via broadcast signals, via amplitude and/or frequency modulation on the television signal, based on analog television encoding standard. Analog television broadcasters may, for example, encode their signals using NTSC, PAL and/or SECAM analog encoding and then modulate these signals onto a VHF or UHF RF carriers, for example.

In digital television (DTV) systems, television broadcasts may be communicated by terrestrial, cable and/or satellite head-ends via discrete (digital) signals, utilizing one of available digital modulation schemes, which may comprise, for example, QAM, VSB, QPSK and/or OFDM. Because the use of digital signals generally requires less bandwidth than analog signals to convey the same information, DTV systems may enable broadcasters to provide more digital channels within the same space otherwise available to analog television systems. In addition, use of digital television signals may enable broadcasters to provide high-definition television (HDTV) broadcasting and/or to provide other non-television related service via the digital system. Available digital television systems comprise, for example, ATSC, DVB, DMB-T/H and/or ISDN based systems. Video and/or audio information may be encoded into digital television signals utilizing various video and/or audio encoding and/or compression algorithms, which may comprise, for example, MPEG-1/2, MPEG-4 AVC, MP3, AC-3, AAC and/or HE-AAC.

Nowadays most TV broadcasts (and similar multimedia feeds), utilize video formatting standard that enable communication of video images in the form of bit streams. These video standards may utilize various interpolation and/or rate conversion functions to present content comprising still and/or moving images on display devices. For example, de-interlacing functions may be utilized to convert moving and/or still images to a format that is suitable for certain types of display devices that are unable to handle interlaced content. TV broadcasts, and similar video feeds, may be interlaced or progressive. Interlaced video comprises fields, each of which may be captured at a distinct time interval. A frame may comprise a pair of fields, for example, a top field and a bottom field. The pictures forming the video may comprise a plurality of ordered lines. During one of the time intervals, video content for the even-numbered lines may be captured. During a subsequent time interval, video content for the odd-numbered lines may be captured. The even-numbered lines may be collectively referred to as the top field, while the odd-numbered lines may be collectively referred to as the bottom field. Alternatively, the odd-numbered lines may be collectively referred to as the top field, while the even-numbered lines may be collectively referred to as the bottom field. In the case of progressive video frames, all the lines of the frame may be captured or played in sequence during one time interval. Interlaced video may comprise fields that were converted from progressive frames. For example, a progressive frame may be converted into two interlaced fields by organizing the even numbered lines into one field and the odd numbered lines into another field.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for interlacing 3D video, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram illustrating an exemplary video system that supports TV broadcasts and/or local multimedia feeds, in accordance with an embodiment of the invention.

FIG. 1B is a block diagram illustrating an exemplary video system that may be operable to provide communication of 3D video, in accordance with an embodiment of the invention.

FIG. 2A is a block diagram illustrating an exemplary video processing system that may be operable to generate video streams comprising 3D video, in accordance with an embodiment of the invention.

FIG. 2B is a block diagram illustrating an exemplary method for decimating frames in view sequences to generate interlaced 3D video, in accordance with an embodiment of the invention.

FIG. 2C is a block diagram illustrating an exemplary method for decimating frames in view sequences to generate interlaced 3D video with alternating fields within each view sequence, in accordance with an embodiment of the invention.

FIG. 3A is a block diagram illustrating an exemplary video processing system that may be operable to receive and process video input comprising 3D video for display, in accordance with an embodiment of the invention.

FIG. 3B is a block diagram illustrating an exemplary method for deinterlacing view sequences during processing of interlaced 3D video, in accordance with an embodiment of the invention.

FIG. 3C is a block diagram illustrating an exemplary method for deinterlacing view sequences with alternating decimated fields within each view sequence during processing of interlaced 3D video, in accordance with an embodiment of the invention.

FIG. 4A is a flow chart that illustrates exemplary steps for interlacing 3D video, in accordance with an embodiment of the invention.

FIG. 4B is a flow chart that illustrates exemplary steps for deinterlacing 3D video, in accordance with an embodiment of the invention.

### DETAILED DESCRIPTION OF THE INVENTION

Certain embodiments of the invention may be found in a method and system for interlacing 3D video. In various embodiments of the invention, a video processing device may generate and/or capture a plurality of view sequences of video frames. The video processing device may then generate a three-dimension (3D) video stream comprising the plurality of view sequences, wherein at least some of the plurality of view sequences may be decimated during the generation of the 3D video stream. The video processing device may determine bandwidth limitations existing during direct and/or indirect transfer or communication of the generated 3D video stream. The decimation may be performed based on this determination of bandwidth limitations. The decimation may be achieved by converting one or more of the plurality of view sequences from progressive to interlaced video. The conversion from progressive video to interlaced video may be performed by removing top or bottom fields in each frame of those one or more view sequences during the conversion to interlaced video. The removed fields may be selected, during such interlacing operations, based on corresponding conversion to interlaced video of one or more corresponding view sequences.

The plurality of view sequences of video frames may comprise, for example, sequences of stereoscopic left and right reference frames. Accordingly, the conversion from progressive video to interlaced video may comprise removing top fields of all frames in the sequence of stereoscopic left reference frames and bottom fields of all frames in the sequence of stereoscopic right reference frames, or bottom fields of all frames in the sequence of stereoscopic left reference frames and top fields of all frames in the sequence of stereoscopic right reference frames. Alternatively, the conversion from progressive video to interlaced video may comprise removing top or bottom fields in the sequences of stereoscopic left and right reference frames, wherein a type of field removed is alternated on frame-by-frame basis within each sequence and is alternated between corresponding frames in the sequences of stereoscopic left and right reference frames. The generated 3D video stream may then be communicated to and/or received by a receiving video processing device. The receiving video processing device may process the received 3D video stream, wherein processing of the received 3D video stream may comprise extracting the plurality of view sequences from the received 3D video stream. In instances where the plurality of view sequences was subjected to conversion from progressive to interlaced video, the receiving video processing device may deinterlace one or more of the plurality of extracted view sequences comprising interlaced video. The deinterlacing may be performed such that video data for a view sequence, which may have been decimated, may be estimated and/or reconstructed based on processing of other view sequences.

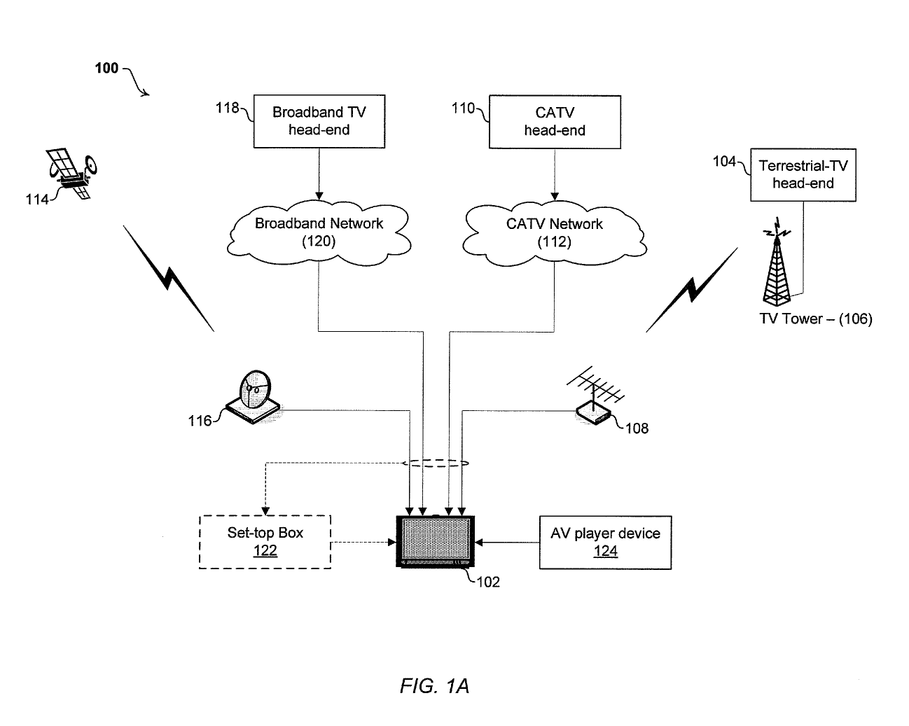

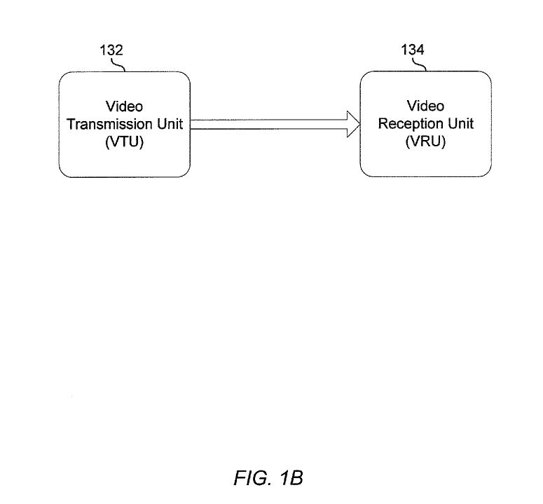

FIG. 1A is a block diagram illustrating an exemplary video system that supports TV broadcasts and/or local multimedia feeds, in accordance with an embodiment of the invention. Referring to FIG. 1A, there is shown a media system 100 which may comprise a display device 102, a terrestrial-TV head-end 104, a TV tower 106, a TV antenna 108, a cable-TV (CATV) head-end 110, a cable-TV (CATV) distribution network 112, a satellite-TV head-end 114, a satellite-TV receiver 116, a broadband-TV head-end 118, a broadband network 120, a set-top box 122, and an audio-visual (AV) player device 124.

The display device 102 may comprise suitable logic, circuitry, interfaces and/or code that enable playing of multimedia streams, which may comprise audio-visual (AV) data. The display device 102 may comprise, for example, a television, a monitor, and/or other display and/or audio playback devices, and/or components that may be operable to playback video streams and/or corresponding audio data, which may be received, directly by the display device 102 and/or indirectly via intermediate devices, such as the set-top box 122, and/or from local media recording/playing devices and/or storage resources, such as the AV player device 124.

The terrestrial-TV head-end 104 may comprise suitable logic, circuitry, interfaces and/or code that may enable over-the-air broadcast of TV signals, via one or more of the TV tower 106. The terrestrial-TV head-end 104 may be enabled to broadcast analog and/or digital encoded terrestrial TV signals. The TV antenna 108 may comprise suitable logic, circuitry, interfaces and/or code that may enable reception of TV signals transmitted by the terrestrial-TV head-end 104, via the TV tower 106. The CATV head-end 110 may comprise suitable logic, circuitry, interfaces and/or code that may enable communication of cable-TV signals. The CATV head-end 110 may be enabled to broadcast analog and/or digital formatted cable-TV signals. The CATV distribution network 112 may comprise suitable distribution systems that may enable forwarding of communication from the CATV head-end 110 to a plurality of cable-TV recipients, comprising, for example, the display device 102. For example, the CATV distribution network 112 may comprise a network of fiber optics and/or coaxial cables that enable connectivity between one or more instances of the CATV head-end 110 and the display device 102.

The satellite-TV head-end 114 may comprise suitable logic, circuitry, interfaces and/or code that may enable down link communication of satellite-TV signals to terrestrial recipients, such as the display device 102. The satellite-TV head-end 114 may comprise, for example, one of a plurality of orbiting satellite nodes in a satellite system. The satellite-TV receiver 116 may comprise suitable logic, circuitry, interfaces and/or code that may enable reception of downlink satellite-TV signals transmitted by the satellite-TV head-end 114. For example, the satellite receiver 116 may comprise a dedicated parabolic antenna operable to receive satellite television signals communicated from satellite television head-ends, and to reflect and/or concentrate the received satellite signal into focal point wherein one or more low-noise-amplifiers (LNAs) may be utilized to down-convert the received signals to corresponding intermediate frequencies that may be further processed to enable extraction of audio/video data, via the set-top box 122 for example. Additionally, because most satellite-TV downlink feeds may be securely encoded and/or scrambled, the satellite-TV receiver 116 may also comprise suitable logic, circuitry, interfaces and/or code that may enable decoding, descrambling, and/or deciphering of received satellite-TV feeds.

The broadband-TV head-end 118 may comprise suitable logic, circuitry, interfaces and/or code that may enable multimedia/TV broadcasts via the broadband network 120. The broadband network 120 may comprise a system of interconnected networks, which enables exchange of information and/or data among a plurality of nodes, based on one or more networking standards, including, for example, TCP/IP. The broadband network 120 may comprise a plurality of broadband capable sub-networks, which may include, for example, satellite networks, cable networks, DVB networks, the Internet, and/or similar local or wide area networks, that collectively enable conveying data that may comprise multimedia content to plurality of end users. Connectivity may be provide via the broadband network 120 based on copper-based and/or fiber-optic wired connection, wireless interfaces, and/or other standards-based interfaces. The broadband-TV head-end 118 and the broadband network 120 may correspond to, for example, an Internet Protocol Television (IPTV) system.

The set-top box 122 may comprise suitable logic, circuitry, interfaces and/or code that may enable processing of TV and/or multimedia streams/signals transmitted by one or more TV head-ends external to the display device 102. The AV player device 124 may comprise suitable logic, circuitry, interfaces and/or code that enable providing video/audio feeds to the display device 102. For example, the AV player device 124 may comprise a digital video disc (DVD) player, a Blu-ray player, a digital video recorder (DVR), a video game console, a surveillance system, and/or a personal computer (PC) capture/playback card. While the set-top box 122 and the AV player device 124 are shown are separate entities, at least some of the functions performed via the top box 122 and/or the AV player device 124 may be integrated directly into the display device 102.

In operation, the display device 102 may be utilized to playback media streams received from one of available broadcast head-ends, and/or from one or more local sources. The display device 102 may receive, for example, via the TV antenna 108, over-the-air TV broadcasts from the terrestrial-TV head end 104 transmitted via the TV tower 106. The display device 102 may also receive cable-TV broadcasts, which may be communicated by the CATV head-end 110 via the CATV distribution network 112; satellite TV broadcasts, which may be communicated by the satellite head-end 114 and received via the satellite receiver 116; and/or Internet media broadcasts, which may be communicated by the broadband-TV head-end 118 via the broadband network 120.

TV head-ends may utilize various formatting schemes in TV broadcasts. Historically, TV broadcasts have utilized analog modulation format schemes, comprising, for example, NTSC, PAL, and/or SECAM. Audio encoding may comprise utilization of separate modulation scheme, comprising, for example, BTSC, NICAM, mono FM, and/or AM. More recently, however, there has been a steady move towards Digital TV (DTV) based broadcasting. For example, the terrestrial-TV head-end 104 may be enabled to utilize ATSC and/or DVB based standards to facilitate DTV terrestrial broadcasts. Similarly, the CATV head-end 110 and/or the satellite head-end 114 may also be enabled to utilize appropriate encoding standards to facilitate cable and/or satellite based broadcasts.

The display device 102 may be operable to directly process multimedia/TV broadcasts to enable playing of corresponding video and/or audio data. Alternatively, an external device, for example the set-top box 122, may be utilized to perform processing operations and/or functions, which may be operable to extract video and/or audio data from received media streams, and the extracted audio/video data may then be played back via the display device 102.

In an exemplary aspect of the invention, the media system 100 may be operable to support three-dimension (3D) video. Various methods may be utilized to capture, generate (at capture or playtime), and/or render 3D video images. One of the more common methods for implementing 3D video is stereoscopic 3D video. In stereoscopic 3D video based applications the 3D video impression is generated by rendering multiple views, most commonly two views: a left view and a right view, corresponding to the viewer's left eye and right eye to generate depth perception in displayed images. In this regard, left view and right view video sequences may be captured and/or processed to enable creating 3D images. The left view and right view data may then be communicated either as separate streams, or may be combined into a single transport stream and only separated into different view sequences by the end-user receiving/displaying device. The communication of stereoscopic 3D video may be by means of TV broadcasts. In this regard, one or more of the TV head-ends may be operable to communicate 3D video content to the display device 102, directly and/or via the set-top box 122. The communication of stereoscopic 3D video may also be performed by use of multimedia storage devices, such as DVD or Blu-ray discs, which may be used to store 3D video data that subsequently may be played back via an appropriate player, such as the AV player device 124. Various compression/encoding standards may be utilized to enable compressing and/or encoding of the view sequences into transport streams during communication of stereoscopic 3D video. For example, the separate left and right view video sequences may be compressed based on MPEG-2 MVP, H.264 and/or MPEG-4 advanced video coding (AVC) or MPEG-4 multi-view video coding (MVC).

In various embodiments of the invention, video content corresponding to generated 3D video may be decimated to reduce, for example, size of video data which must be communicated to the presentation end-devices, directly via 3D TV broadcasts and/or indirectly via media storage devices which may be read via appropriate AV player devices such as the AV player 124. Most of the present video transport infrastructure, whether for direct or indirect communication, may be tailored to 2D video. Accordingly, in instances where the 3D video content comprises a plurality of views, capturing and/or generating each of the view sequences in 3D video at the upper limits of the 2D video support infrastructure may cause some issue, such as bandwidth limitations, during transfer of 3D video data. For example, current video data transfer infrastructure, whether via TV broadcast and/or via media storage devices, may be tailored to 2D video operating, at most, in the 1080p60 mode. Accordingly, where each of view sequences in 3D TV is captured individually as 1080p60 video, the bandwidth required for video data transfers during communication of corresponding 3D video content may necessitate transfer bandwidth which may be a multiple of the maximum bandwidth currently utilized and/or supported during video transfer and/or broadcasts. Accordingly, in an exemplary aspect of the invention, in instances where increases of bandwidth required for video data transfer and/or communication of 3D video content may not be feasible and/or desirable, the 3D video content may be processed to reduce total size of video data communicated.

For example, in instances where the 3D video may comprise a plurality of view sequences of video frames, comprising stereoscopic left and right view sequences for example, at least some of the view sequences may be decimated to reduce the size of video data corresponding to each of these view sequences. Exemplary methods for decimating the view sequences may comprise converting the view sequences to interlaced video when these view sequence are generated and/or captured as progressive video. In instances where the generated 3D video may comprise stereoscopic left and right view sequences, each of the stereoscopic left and right view sequences may be captured and/or generated as 1080p60 video. Combining the stereoscopic left and right view sequences may then necessitate doubling the bandwidth during communication of 3D video. Consequently, each of the stereoscopic left and right view sequences may be converted to interlaced video instead, such as 1080i60 video, to half the bandwidth required for communicating the corresponding 3D video.

At the receiving side, where the 3D video comprises view sequences with decimated video data, the view sequences may be processed such that at least some of the decimated video data may be recreated. For example, in instances where received 3D video comprises stereoscopic left and right view sequences originally captured as progressive video but subsequently converted to interlaced video, processing the stereoscopic left and right view sequences extracted from broadcast streams and/or read via AV player devices may comprise utilizing deinterlacing techniques. In an exemplary aspect of the invention, any such deinterlacing performed on a view sequence may comprise utilizing video data of fields in other view sequences. In instances where received 3D video comprises stereoscopic left and right view sequences converted to interlaced video, deinterlacing one view sequence, for example the stereoscopic left view sequence, may comprise generating video data for missing fields utilizing video data of the corresponding fields in the other view sequence (i.e., the right view sequence).

FIG. 1B is a block diagram illustrating an exemplary video system that may be operable to provide communication of 3D video, in accordance with an embodiment of the invention. Referring to FIG. 1B, there is shown a 3D video transmission unit (3D-VTU) 132 and a 3D video reception unit (3D-VRU) 134.

The 3D-VTU 132 may comprise suitable logic, circuitry, interfaces and/or code that may be operable to generate video streams that may comprise encoded/compressed 3D video data, which may be communicated, for example, to the 3D-VRU 134 for display and/or playback. The 3D video generated via the 3D-VTU 132 may be communicated via TV broadcasts, by one or more TV head-ends. The 3D video generated via the 3D-VTU 132 may be also stored into multimedia storage devices, such as DVD or Blu-ray discs.

The 3D-VRU 134 may comprise suitable logic, circuitry, interfaces and/or code that may be operable to receive and/or process video streams comprising 3D video data for playback. The 3D-VRU 134 may be operable to, for example, receive and/or process transport streams comprising 3D video data, which may be communicated directly by, the 3D-VTU 132 for example, via TV broadcasts. The 3D-VRU 134 may also be operable to receive and/or process video streams read from multimedia storage devices which may be played directly via the 3D-VRU 134 and/or via local suitable player devices. In this regard, the operations of the 3D-VRU 134 may be performed, for example, via the display device 102, the set-top box 122, and/or the AV player device 124 of FIG. 1A. The received video streams may comprise encoded/compressed 3D video data. Accordingly, the 3D-VRU 134 may be operable to process the received video stream to extract various video contents in the transport stream, and may be operable to decode and/or process the extracted video streams and/or contents to facilitate display operations.

In operation, the 3D-VTU 132 may be operable to generate video streams comprising 3D video data. The 3D-VTU 132 may compress and/or encode, for example, the 3D video data as stereoscopic 3D video comprising left view and right view sequences. The 3D-VRU 134 may be operable to receive and process the video streams to facilitate playback of video content included in the video stream via appropriate display devices. In this regard, the 3D-VRU 134 may be operable to, for example, demultiplex received transport stream into encoded 3D video streams and/or additional video streams. The 3D-VRU 134 may decode and/or uncompress the 3D video data in the received video stream for display.

In various embodiments of the invention, the 3D-VTU 132 may be operable to decimate generated and/or captured 3D video content, and/or 3D-VRU 134 may operable to process received 3D video content comprising such decimated video data, utilizing video data in one or more other view sequences, substantially as described with regard to, for example, FIG. 1A.

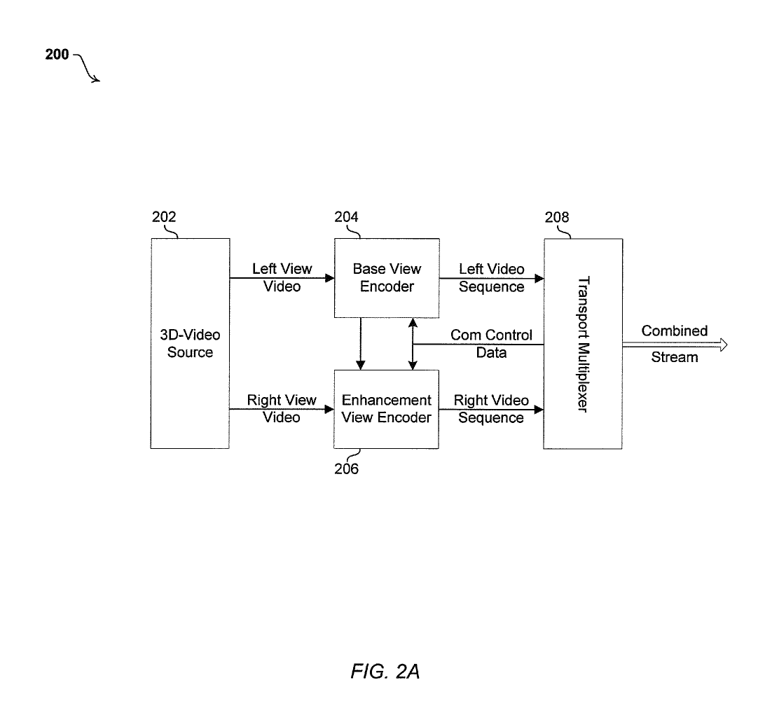

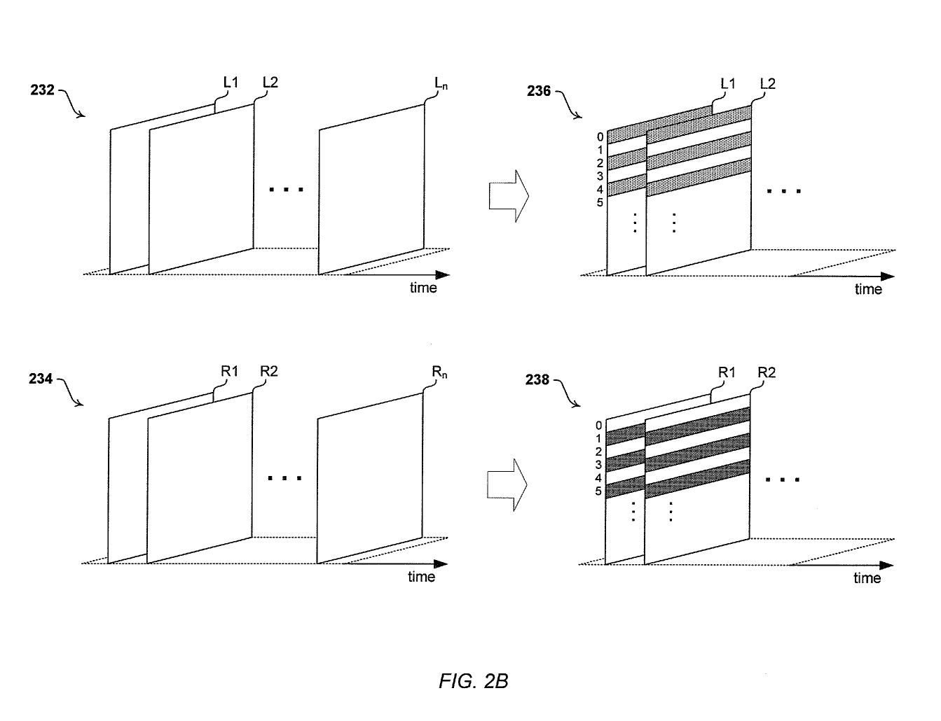

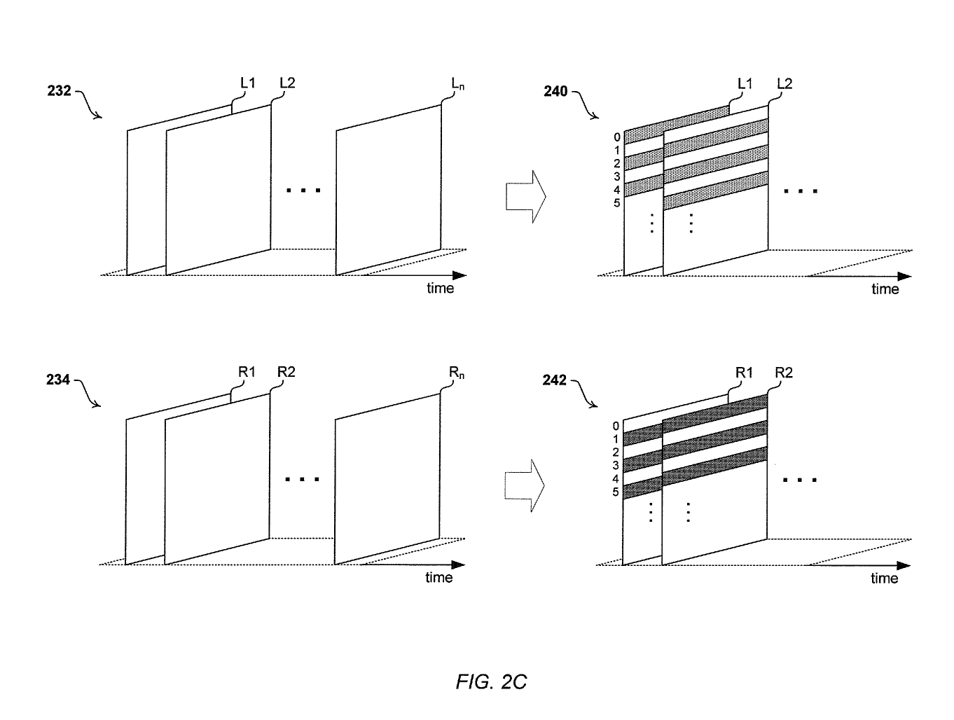

FIG. 2A is a block diagram illustrating an exemplary video processing system that may be operable to generate video streams comprising 3D video, in accordance with an embodiment of the invention. Referring to FIG. 2A, there is shown a video processing system 200, a 3D-video source 202, a base view encoder 204, an enhancement view encoder 206, and a transport multiplexer 208.

The video processing system 200 may comprise suitable logic, circuitry, interfaces and/or code that may be operable to capture, generate, and/or process 3D video data, and to generate transport streams comprising the 3D video. The video processing system 200 may comprise, for example, the 3D-video source 202, the base view encoder 204, the enhancement view encoder 206, and/or the transport multiplexer 208. The video processing system 200 may be integrated into the 3D-VTU 132 to facilitate generation of video and/or transport streams comprising 3D video data.

The 3D-video source 202 may comprise suitable logic, circuitry, interfaces and/or code that may be operable to capture and/or generate source 3D video contents. The 3D-video source 202 may be operable, for example, to generate stereoscopic 3D video comprising left view and right view video data from the captured source 3D video contents. The left view video and the right view video may be communicated to the base view encoder 204 and the enhancement view encoder 206, respectively, for video compressing.

The base view encoder 204 may comprise suitable logic, circuitry, interfaces and/or code that may be operable to encode the left view video from the 3D-video source 202, for example on frame by frame basis. The base view encoder 204 may be operable to utilize various video encoding and/or compression algorithms such as those specified in MPEG-2, MPEG-4, AVC, VC1, VP6, and/or other video formats to form compressed and/or encoded video contents for the left view video from the 3D-video source 202. In addition, the base view encoder 204 may be operable to communicate information, such as the scene information from base view coding, to the enhancement view encoder 206 to be used for enhancement view coding.

The enhancement view encoder 206 may comprise suitable logic, circuitry, interfaces and/or code that may be operable to encode the right view video from the 3D-video source 202, for example on frame by frame basis. The enhancement view encoder 206 may be operable to utilize various video encoding and/or compression algorithms such as those specified in MPEG-2, MPEG-4, AVC, VC1, and/or other video formats to form compressed or encoded video content for the right view video from the 3D-video source 202. Although a single enhancement view encoder 206 is illustrated in FIG. 2B, the invention may not be so limited. Accordingly, any number of enhancement view video encoders may be used for processing the left view video and the right view video generated by the 3D-video source 202 without departing from the spirit and scope of various embodiments of the invention.

The transport multiplexer 208 may comprise suitable logic, circuitry, interfaces and/or code that may be operable to merge a plurality of video sequences into a single compound video stream. The combined video stream may comprise the left (base) view video sequence, the right (enhancement) view video sequence, and a plurality of addition video streams, which may comprise, for example, advertisement streams.

In operation, the 3D-video source 202 may be operable to capture and/or generate source 3D video contents to produce, for example, stereoscopic 3D video data that may comprise a left view video and a right view video for video compression. The left view video may be encoded via the base view encoder 204 producing the left (base) view video sequence. The right view video may be encoded via the enhancement view encoder 206 to produce the right (enhancement) view video sequence. The base view encoder 204 may be operable to provide information such as the scene information to the enhancement view encoder 206 for enhancement view coding, to enable generating depth data, for example. Transport multiplexer 208 may be operable to combine the left (base) view video sequence and the right (enhancement) view video sequence to generate a combined video stream. Additionally, additional video streams, comprising advertisement content for example, may be multiplexed into the combined video stream via the transport multiplexer 208. The video stream may then be communicated, for example, to the 3D-VRU 134, substantially as described with regard to FIGS. 1A and 1B.

In an exemplary aspect of the invention, the video processing system 200 may be operable to decimate video data corresponding to the 3D video content of generated and/or captured 3D video, to comply with, for example, bandwidth and/or operational limitations of mediums utilized in conjunction with a specific transfer mode for communicating the generated 3D video content. In this regard, transfer mode may comprise direct communication of 3D video content, for example via TV broadcast, which may enable communication of the video content over the air and/or via wired connections, and/or indirect communication of the 3D video content, for example via use of storage devices and corresponding player devices, such as Blu-ray discs and players. In instances where the video may be generated and/or captured as progressive video, decimating video data may be achieved by converting at least part of the 3D video content to interlaced video. For example, the video processing system 200 may be utilized to generate 3D video that comprises stereoscopic left and right view sequences of frames. In this regard, the 3D-video source 202 may be operable to capture and/or generate each of the stereoscopic left and right view video as progressive video, comprising a plurality of frames.

The transport multiplexer 208 may be operable to determine operational limitations, such as transfer bandwidth, based on the transfer mode of communication of the generated 3D video content, and may provide control information, to the base view encoder 204 and/or the enhancement view encoder 206, based on the determination. Accordingly, the base view encoder 204 and/or the enhancement view encoder 206 may use the control information to perform decimation of the 3D video content. In this regard, required video data decimation may be performed, via the base view encoder 204 and/or the enhancement view encoder 206. For example, the video data decimation may be performed by converting the stereoscopic left and right view video from progressive to interlaced video. The video data decimation may enable reducing the total size of the 3D video content incorporated into the combined stream, for example, by half.

FIG. 2B is a block diagram illustrating an exemplary method for decimating frames in view sequences to generate interlaced 3D video, in accordance with an embodiment of the invention. Referring to FIG. 2B, there is shown an input left view (LV) video stream 232, which may comprise a plurality of video frames corresponding to, for example, stereoscopic left view in 3D video, and an input right view (RV) video stream 234, which may comprise a plurality of video frames corresponding to, for example, stereoscopic right view in 3D video. The input LV video stream 232 and/or the input RV video stream 234 may be encoded based on a compression standard, such as MPEG. Each of the input LV video stream 232 and/or the input RV video stream 234 may correspond to stereoscopic video view generated and/or captured, as progressive video, via the video processing system 200 for example.

Also shown in FIG. 2B is a decimated left view (LV) video stream 236 and a decimated right view (RV) video stream 238, which may be generated, via the video processing system 200 for example, based on the input LV video stream 232 and the input RV video stream 234, respectively. The decimated LV video stream 236 may comprise a plurality of video fields corresponding to interlaced video generated based on the input LV video stream 232. Similarly, the decimated RV video stream 238 may comprise a plurality of video fields corresponding to interlaced video generated based on the input RV video stream 234. The decimated LV video stream 236 and/or the decimated RV video stream 238 may be generated for communication via TV broadcasts and/or for transfer to multimedia storage devices, such as a Blu-ray disc, to enable playback using an appropriate AV player device, such as the AV player device 124.

In operation, the video processing system 200 may generate the decimated LV video stream 236 and/or the decimated RV video stream 238 based on the input LV video stream 232 and/or the input RV video stream 234, to facilitate video data decimation, substantially as described with regard to FIG. 2A. For example, in instances where the input LV video stream 232 and/or the input RV video stream 234 comprise progressive video content, video processing system 200 may be operable to convert these streams to interlaced video to reduce the bandwidth required for video data transfer. Because there is a high degree of correlation between the left and right view data in stereoscopic 3D video, the decimation of the video data may be performed such that removed data in a view stream may be recreated and/or simulated, at the receiving side, using, for example, video data in corresponding view streams. In this regard, bottom fields, comprising odd-numbered lines, in each of the frames in the input LV video stream 232 may be decimated out when generating the decimated LV video stream 236, while top fields, comprising even-numbered lines, in each of the frames in the input RV video stream 234 may be decimated out when generating the decimated RV video stream 238.

FIG. 2C is a block diagram illustrating an exemplary method for decimating frames in view sequences to generate interlaced 3D video with alternating fields within each view sequence, in accordance with an embodiment of the invention. Referring to FIG. 2C, there is shown the input left view (LV) video stream 232 and the input right view (RV) video stream 234, substantially as described with regard to, for example, FIG. 2B.

Also shown in FIG. 2C is a decimated left view (LV) video stream 240 and a decimated right view (RV) video stream 242, which may be generated, via the video processing system 200 for example, based on the input LV video stream 232 and the input RV video stream 234, respectively. The decimated LV video stream 240 may be similar to the decimated LV video stream 236 of FIG. 2B, and may also comprise a plurality of video fields corresponding to interlaced video generated based on the input LV video stream 232. Similarly, the output right view (RV) video stream 242 may be similar to the decimated RV video stream 238 of FIG. 2B, and may also comprise a plurality of video fields corresponding to interlaced video generated based on the input RV video stream 234.

In operation, the video processing system 200 may be operable to generate the decimated LV video stream 240 and/or the decimated RV video stream 242 based on the input LV video stream 232 and/or the input RV video stream 234, to facilitate video data decimation. The manner in which the decimated LV video stream 240 and/or the decimated RV video stream 242 may be generated, however, may differ from the generation of the decimated LV video stream 236 and/or the decimated RV video stream 238 as described with regard to FIG. 2B. In this regard, rather than removing the same type of fields (e.g. top or bottom fields) in all frames of each view stream, the type of fields decimated out may be alternated within each view stream on frame-to-frame basis. Furthermore, for corresponding view streams, the left and right views in stereoscopic 3D video for example, the opposite type of fields may be decimated out in corresponding frames (i.e. similarly positioned within the sequence) of corresponding view streams during video decimation operations. For example, as demonstrated by FIG. 2C, the bottom fields, comprising odd-numbered lines, of odd-numbered frames (e.g. L1) and the top fields, comprising even-numbered lines, of even-numbered frames (e.g. L2) of the input LV video stream 232 may be decimated out when generating the decimated LV video stream 240. At the same time, during generation of the decimated RV video stream 242, the top fields, comprising even-numbered lines, in odd-numbered frames (e.g. R1) and the bottom fields, comprising odd-number lines, in even-numbered frames (e.g. R2) of the input RV video stream 234 may be decimated out.

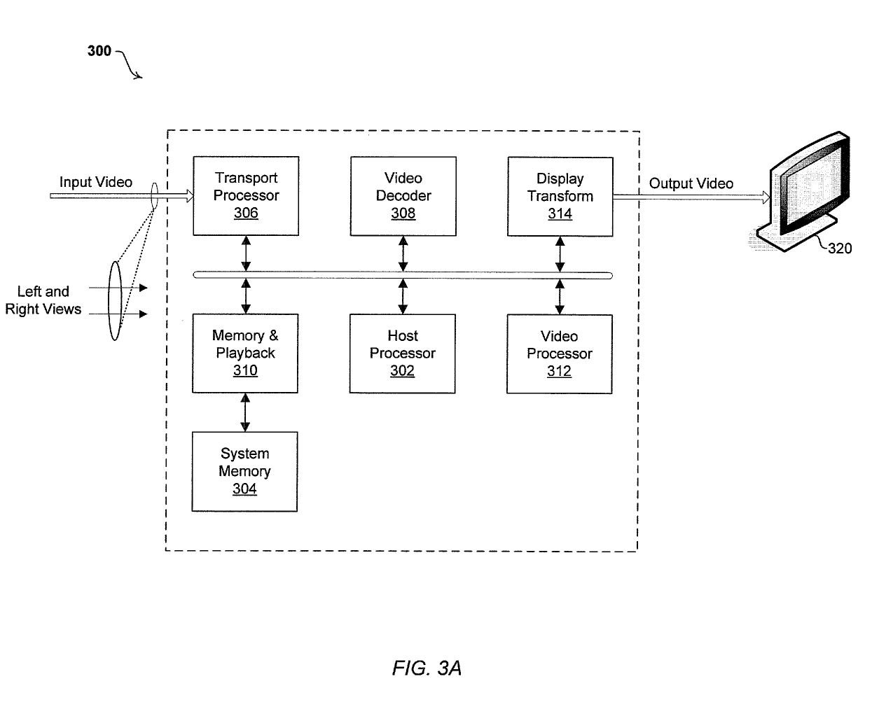

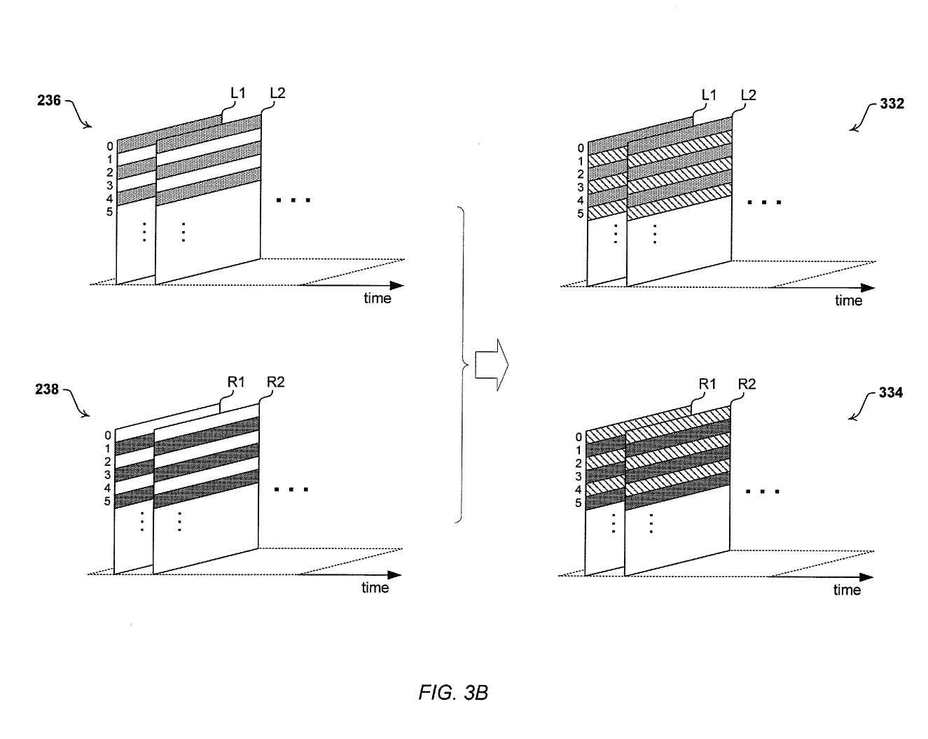

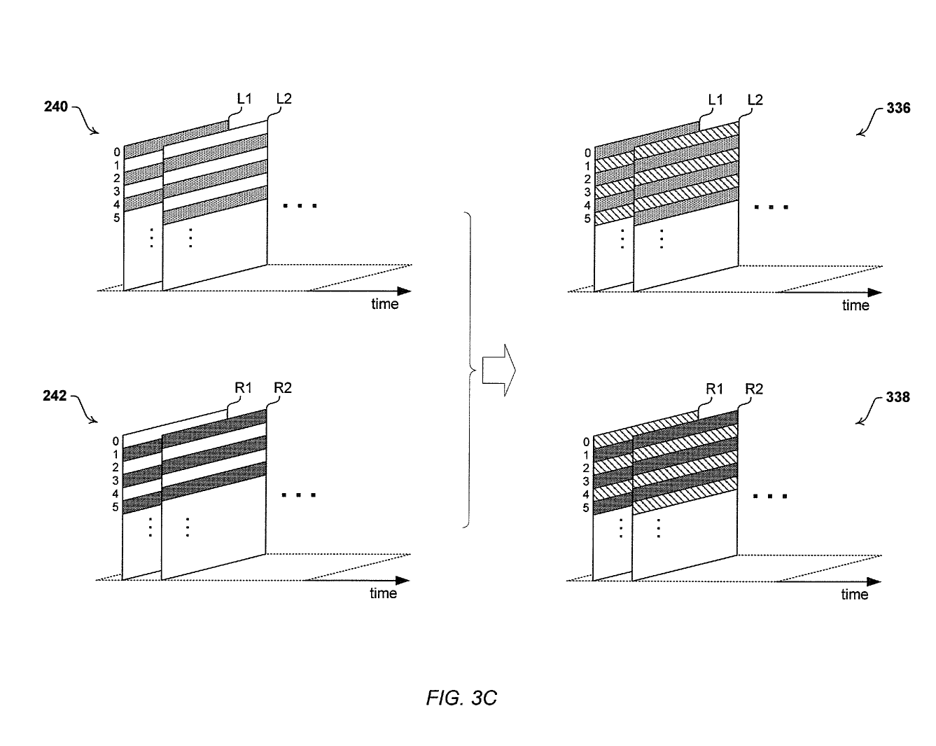

FIG. 3A is a block diagram illustrating an exemplary video processing system that may be operable to receive and process video input comprising 3D video for display, in accordance with an embodiment of the invention. Referring to FIG. 3A there is shown a video processing system 300, a host processor 302, a system memory 304, a transport processor 306, an video decoder 308, a memory and playback module 310, a video processor 312, a display transform module 314, and a display 320.

The video processing system 300 may comprise suitable logic, circuitry, interfaces and/or code that may be operable to receive and process 3D video data in a compression format and may render reconstructed output video for display. The video processing system 300 may comprise, for example, the host processor 302, the system memory 304, the transport processor 306, the video decoder 308, the memory and playback module 310, the video processor 312, and/or the display transform module 314. For example, the video processing system 300 may be integrated into the 3D-VRU 134 to facilitate reception and/or processing of transport streams comprising 3D video content communicated by the 3D-VTU 132. The video processing system 300 may be operable to handle interlaced video fields and/or progressive video frames. In this regard, the video processing system 300 may be operable to decompress and/or up-convert interlaced video and/or progressive video. The video fields, for example, interlaced fields and/or progressive video frames may be referred to as fields, video fields, frames or video frames.

The host processor 302 may comprise suitable logic, circuitry, interfaces and/or code that may be operable to process data and/or control operations of the video processing system 300. In this regard, the host processor 302 may be operable configure and/or controlling operations of various other components and/or subsystems of the video processing system 300, by providing, for example, control signals to various other components and/or subsystems of the video processing system 300. The host processor 302 may also control data transfers within the video processing system 300, during video processing operations for example. The host processor 302 may enable execution of applications, programs and/or code, which may be stored in the system memory 304, to enable, for example, performing various video processing operations such as decompression, motion compensation operations, interpolation or otherwise processing 3D video data. The system memory 304 may comprise suitable logic, circuitry, interfaces and/or code that may operable to store information comprising parameters and/or code that may effectuate the operation of the video processing system 300. The parameters may comprise configuration data and the code may comprise operational code such as software and/or firmware, but the information need not be limited in this regard. Additionally, the system memory 304 may be operable to store 3D video data, for example, data that may comprise left and right views of stereoscopic image data.

The transport processor 306 may comprise suitable logic, circuitry, interfaces and/or code that may be operable to receive input video transport stream, and to demultiplex and/or parse received transport streams to extract constituent streams and/or sequences within them. The transport processor 306 may also perform additional security operations such as digital rights management (DRM). The extracted streams and/or sequences may then be decoded via the video decoder 308. The video decoder 308 may comprise suitable logic, circuitry, interfaces and/or code that may be operable to decompress and/or decode video data that may be carried via received transport streams. The compressed video data in the received transport stream may comprise 3D video data corresponding to a plurality of view stereoscopic video sequences of frames or fields, such as left and review views. The received video data may be compressed and/or encoded via MPEG-2 transport stream (TS) protocol or MPEG-2 program stream (PS) container formats, for example. In various embodiments of the invention, the left view data and the right view data may be received in separate streams or separate files. In this instance, the video decoder 308 may decompress the received separate left and right view video data based on, for example, MPEG-2 MVP, H.264 and/or MPEG-4 advanced video coding (AVC) or MPEG-4 multi-view video coding (MVC). In other embodiments of the invention, the stereoscopic left and right views may be combined into a single sequence of frames. For example, side-by-side, top-bottom and/or checkerboard lattice based 3D encoders may convert frames from a 3D stream comprising left view data and right view data into a single-compressed frame and may use MPEG-2, H.264, AVC and/or other encoding techniques. In this instance, the video data may be decompressed by the video decoder 308 based on MPEG-4 AVC and/or MPEG-2 main profile (MP), for example.

The memory and playback module 310 may comprise suitable logic, circuitry interfaces and/or code that may be operable to buffer 3D video data, for example, left and/or right views, while it is being transferred from one component to another during video related processing operations. In addition, the memory and playback module 310 may buffer decompressed reference frames and/or fields, for example, during frame interpolation, by the display transform module 314. The memory and playback module 310 may exchange control signals with the host processor 302 for example and/or may write data to the system memory 304 for longer term storage.

The video processor 312 may comprise suitable logic, circuitry, interfaces and/or code that may be operable to perform video processing operations on received video data to facilitate generating output video streams, which may be played via the display 320. The video processor 312 may be operable, for example, to generate video frames that may provide 3D video playback via the display 320 based on a plurality of view sequences extracted from the received transport streams. In this regard, the video processor 312 may utilize the video data, such as luma and/or chroma data, in the received view sequences of frames and/or fields. In an exemplary aspect of the invention, the video processor 312 may be operable to estimate and/or reconstruct video data that may have been removed from 3D video content received via the video processing system 300 during 3D video communication. In this regard, the video processor may be operable, for example, to deinterlace one or more view sequences of received 3D video which have been converted from progressive to interlaced video to facilitate video data decimation, substantially as described with regard to, for example, FIG. 1B.

The display transform module 314 may comprise suitable logic, circuitry, interfaces and/or code that may be operable to process video data generated and/or processed via the video processing system 300 to generate an output video stream that is suitable for playback via the display 320. In this regard, the display transform module 314 may perform, for example, frame upconversion based on motion estimation and/or motion compensation to increase the number of frames where the display 320 has higher frame rate than the input video streams. In instances where the display 320 may not be 3D capable, to convert 3D video data generated and/or processed via the video processing system 300 to 2D output video. In this regard, the 3D video converted to 2D output stream may comprise blended 3D input video and 3D graphics.

The display 320 may comprise suitable logic, circuitry, interfaces and/or code that may be operable to receive reconstructed fields and/or frames of video data after processing in the display transform module 314 and may display corresponding images. The display 320 may be a separate device, or the display 320 and the video processing system 300 may implemented as single unitary device. The display 320 may be operable to perform 2D and/or 3D video display. In this regard, a 2D display may be operable to display video that was generated and/or processed utilizing 3D techniques.

In operation, the video processing system 300 may be utilized to facilitate reception and processing of transport stream comprising video data, and to generate and process output video streams that are playable via a local display device, such as the display 320. Processing the received transport stream may comprise demultiplexing the transport stream to extract plurality of compressed video, which may correspond to, for example, view sequences and/or additional information. Demultiplexing the transport stream may be performed within the video decoder 308, or via a separate component (not shown). The video decoder 308 may be operable to receive the transport streams comprising compressed stereoscopic video data, in multi-view compression format for example, and to decode and/or decompress that video data. For example, the received transport streams may comprise left and right stereoscopic views. The video decoder 308 may be operable to decompress the received stereoscopic video data and may buffer the decompressed data via the memory and playback module 310. The decompressed video data may then be processed to enable playback via the display 320. The video processor 312 may be operable to generate output video streams, which 3D and/or 2D, based on decompressed video data. In this regard, where stereoscopic 3D video is utilized, the video processor 312 may process decompressed reference frames and/or fields, corresponding to plurality of view sequences, which may be retrieved via the memory and playback module 310, to enable generation of corresponding 3D video steam that may be further processed via the display transform module 314 and/or the viewing controller 252 prior to playback via the display 320. For example, where necessary the display transform module 314 may perform motion compensation and/or may interpolate pixel data in one or more frames between the received frames in order to enable the frame rate up-conversion. The viewing controller 252 may be utilized to provide local graphics processing, to enable splicing, for example, graphics into the generated and enhanced video output stream, and the final video output stream may then be played via the display 320.

In various embodiments of the invention, the video processing system 300 may be operable to process 3D video content which may comprise decimated video data. For example, input video streams received via the video processing system 300 may comprise a plurality of view sequences, one or more of which may initially be generated and/or captured as progressive video, and may then be converted to interlaced video to facilitate 3D video communication, substantially as described with regard to FIGS. 1B and/or 2A. The received 3D video content may comprise, for example, stereoscopic 3D video within the left and right views. Accordingly, the video processing system 300 may be utilized to process such 3D video content, extracting view sequences comprising interlaced video, and performing, via the video processor 312 for example, deinterlacing operations on the video view sequences. The deinterlacing operations may comprise, for example, recreating and/or simulating video data which may have been removed during video content decimation operations performed at the sending side. The video data reconstructed and/or generated during video deinterlacing operations on a view sequence may be based on, for example, other video data in that view sequence and/or on video data in other view sequences. For example, the received video stream may comprise stereoscopic 3D video content comprising left and right view sequences of video fields. Accordingly, during deinterlacing of the left view sequence, video data corresponding to missing and/or decimated video fields may be generated and/or reconstructed based on video data corresponding to remaining video fields in the left view sequence and/or video fields in the right view sequence.

FIG. 3B is a block diagram illustrating an exemplary method for deinterlacing view sequences during processing of interlaced 3D video, in accordance with an embodiment of the invention. Referring to FIG. 3B, there is shown the decimated left view (LV) video stream 236 and the decimated right view (RV) video stream 238 of FIG. 2B. The decimated LV video stream 236 and/or the decimated RV video stream 238 may be extracted, via the video processing system 300 for example, from video content received via direct communication (e.g. TV broadcasts) or indirect communication (e.g. read from media storage device, such as a Blu-ray disc, by an AV player device).

Also shown in FIG. 3B is an output left view (LV) video stream 332 and an output right view (RV) video stream 334, which may be generated, via the video processing system 300 for example, based on the decimated LV video stream 236 and the decimated RV video stream 238, respectively. The output LV video stream 332 may comprise a plurality of video frames corresponding to progressive video generated based on the decimated LV video stream 236, which comprises interlaced video. Similarly, the output RV video stream 334 may comprise a plurality of video frames corresponding to progressive video generated based on the decimated RV video stream 238, which comprises interlaced video. The output LV video stream 332 and/or the output RV video stream 334 may be playable, directly and/or after some additional processing in the video processing system 300, via the display 320 to provide 3D video.

In operation, the video processing system 300 may extract the decimated LV video stream 236 and/or the decimated RV video stream 238 from received input video to facilitate 3D video display. In various embodiments of the invention, video data which may have been decimated to facilitate video content transfers may be reconstructed during processing of the extracted 3D video views. For example, in instances where the decimated LV video stream 236 and/or the decimated LV video stream 236 may comprise interlaced video content, the video processing system 300 may be operable to deinterlace these streams, converting them, for example, to progressive video by generating video data corresponding to the missing fields in each of the view streams. The video data corresponding to the missing fields may be generated based on video data in existing fields in each of the view sequences. For example, during generation of the output LV video stream 332, video data for bottom fields, comprising odd-numbered lines, in each of the frames in the decimated LV video stream 236 may be generated using video data of top fields in the same frames of the decimated LV video stream 236. Similarly, during generation of the output RV video stream 334, video data for bottom fields, comprising odd-numbered lines, in each of the frames in the decimated RV video stream 238 may be generated using video data of top fields in the same frames of the decimated RV video stream 238. The selection of video data used during reconstruction operations may be performed on a line-to-line basis, based on the closest previous line in the opposite field. For example, when generating video data for line 3 in frame L2, video data corresponding to line 2 may be utilized.

In an exemplary aspect of the invention, due to the high degree of correlation between at least some views, such as left and right views in stereoscopic 3D video, video data from other view steams may also be utilized during reconstruction of missing video data in a view stream. For example, during generation of the output LV video stream 332, video data for bottom fields in each of the frames (e.g. L1) in the decimated LV video stream 236 may be generated based on video data of top fields in the same frames of the decimated LV video stream 236 and/or video data in the bottom fields of corresponding frames (e.g. R1) of the decimated RV video stream 238. Similarly, during generation of the output RV video stream 334, video data for top fields in each of the frames (e.g. R1) in the decimated RV video stream 236 may be generated based on video data in the bottom fields of the same frames for the decimated RV video stream 238 and/or video data of top fields in corresponding frames (e.g. L1) of the decimated LV video stream 236.

In instances where video data of other view streams are utilized during video data reconstruction operations, the video data used may be adjusted and/or processed to account for variation between the views. For example, in instance where video data for the decimated LV video stream 236 are utilized to reconstruct data for the output RV video stream 334, the video data may be adjusted to account for variations in, for example, viewing angles for the left and right views. The viewing angles may be preconfigured, based on the predetermined viewing angles between the left and right eyes. The viewing angles may also be adjusted based on, for example, user input, which may provided prior to start of 3D video playback and/or dynamically during 3D video playback. In some embodiments of the invention, information utilized for reconstruction, such as viewing angles may be embedded in the communicated 3D video content.

FIG. 3C is a block diagram illustrating an exemplary method for deinterlacing view sequences with alternating decimated fields within each view sequence during processing of interlaced 3D video, in accordance with an embodiment of the invention. Referring to FIG. 3C, there is shown the decimated left view (LV) video stream 240 and the decimated right view (RV) video stream 242 of FIG. 2B. The decimated LV video stream 240 and/or the decimated RV video stream 242 may be extracted, via the video processing system 300 for example, from video content received via direct communication (e.g. TV broadcasts) or indirect communication (e.g. read from media storage device, such as a Blu-ray disc, via an appropriate AV player device).

Also shown in FIG. 3C is an output left view (LV) video stream 336 and an output right view (RV) video stream 338, which may be generated, via the video processing system 300 for example, based on the decimated LV video stream 240 and the decimated RV video stream 242, respectively. The output LV video stream 336 may comprise a plurality of video frames corresponding to progressive video generated based on the decimated LV video stream 240, which comprises interlaced video. Similarly, the output RV video stream 338 may comprise a plurality of video frames corresponding to progressive video generated based on the decimated RV video stream 242, which comprises interlaced video. The output LV video stream 336 and/or the output RV video stream 338 may be playable, directly and/or after some additional processing in the video processing system 300, via the display 320 to provide 3D video.

In operation, the video processing system 300 may extract the decimated LV video stream 240 and/or the decimated RV video stream 242 from received input video to facilitate 3D video display, substantially as described with regard to FIG. 3A. The output LV video stream 336 and/or the output RV video stream 338 may be generated using video data reconstruction operations, substantially as described with regard to the generation of output LV video stream 332 and/or the output RV video stream 334 in FIG. 3B. The manner by which missing video data may be recreated and/or generated for the LV video stream 240 and/or the decimated RV video stream 242 may differ, however, due to the variations in the structure of the decimated view streams. For example, because the decimated fields within each view stream are alternated on a frame-by-frame basis, the video data for missing fields in frames of the view stream may be generated using video data of existing fields within the same frames, and/or video data of corresponding (similar) fields in previous and/or following frames. For example, during generation of the output LV video stream 332, video data for top field, comprising even-numbered lines, in frame L2 may be generated using video data of bottom field in frame L2 and/or video data of top field in frame L1 (and/or frame L3, the following frame, which is not shown). The selection of video data used during reconstruction operations may be performed on a line-to-line basis, based on the closest previous line in the opposite field. For example, when generating video data for line 3 in frame L2, video data corresponding to line 2 may be utilized.

Similarly, in instances where video data from other view steams may be utilized during reconstruction of missing video data in a view stream, the manner by which missing video data may be recreated and/or generated for the LV video stream 240 and/or the decimated RV video stream 242 may differ based on variations in the structure of the corresponding decimated view streams. For example, during generation of the output RV video stream 338, video data for the bottom fields, comprising odd-numbered lines, in even-numbered frames (e.g. R2) may be generated based on, at least, video data of bottom fields of corresponding frames (e.g. L2) in the decimated LV video stream 240. Also, during generation of the output RV video stream 338, video data for the top fields, comprising even-numbered lines, in odd-numbered frames (e.g. R1) may be generated based on, at least in part, video data of top fields of corresponding frames (e.g. L2) in the decimated LV video stream 240.

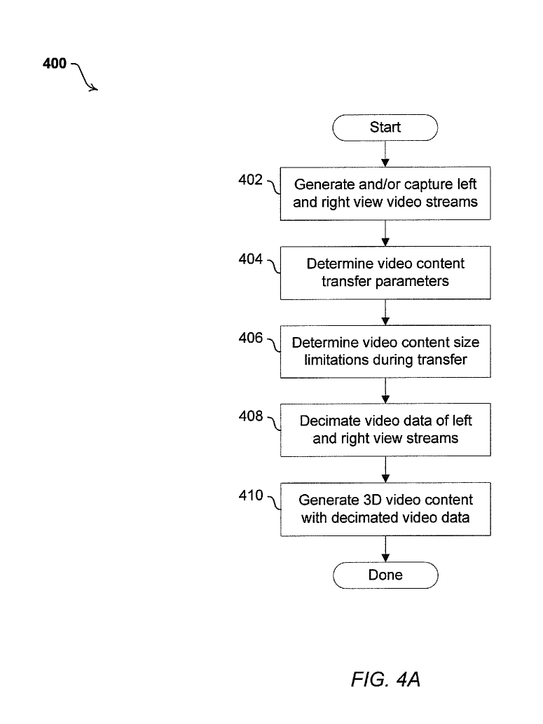

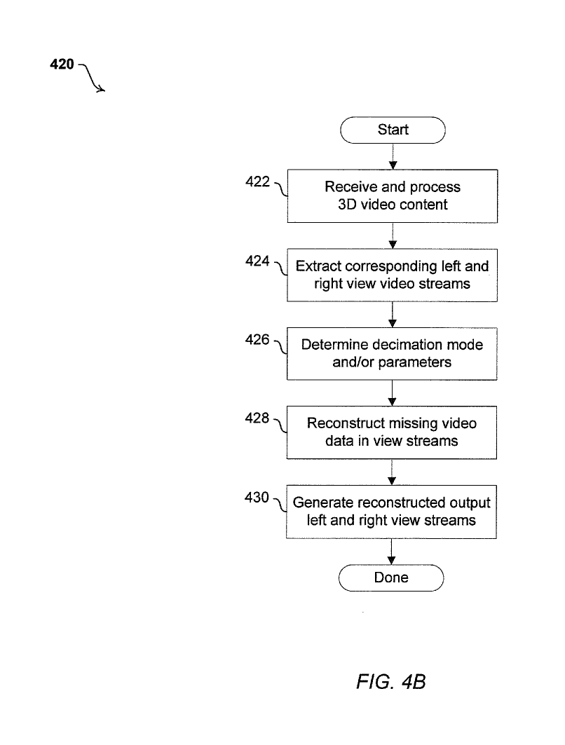

FIG. 4A is a flow chart that illustrates exemplary steps for interlacing 3D video, in accordance with an embodiment of the invention. Referring to FIG. 4A, there is shown a flow chart 400 comprising a plurality of exemplary steps that may be performed to enable interlacing 3D video.

In step 402, a plurality of view sequences may be generated and/or captured during generation of 3D video content. For example, the video processing system 200 may be operable to generate and/or capture, via the 3D video source 202, to generate and/or capture left and right view video streams. In step 404, 3D video content transfer parameters may be determined. For example, the transport multiplexer 208 may be operable to determine parameters of the video content transfer during communication of 3D video content generated via the video processing system 200. In this regard, video content transfer may comprise direct communication (e.g. via TV broadcasts) and/or indirect communication (e.g. via storage into multimedia storage devices such as Blu-ray discs, which may then be read for 3D video playback). In step 406, video content size limitations during transfer may be determined. For example, the transport multiplexer 208 may be operable to determine the maximum bandwidth available during video content transfer, during direct and/or indirect communication of 3D video content. In this regard, because video content transfer may be tailored to support 2D video, and because each view sequence in 3D video may be generated and/or captured as a separate 2D video stream, the generated 3D video content, as generated, may require transfer bandwidth that may be larger than what is supported.

In step 408, video data corresponding to the generated 3D video content may be reduced to comply with the limitations of the video content transfer infrastructure used in communicating the 3D video content. For example, the video processing system 200 may be operable, via the base view encoder 204 and/or enhancement view encoder 206, to decimate video data for the left and right view streams, for example by converting them from progressive to interlaced video. In step 410, 3D video content comprising reduced video data may be generated. For example, in the video processing system 200, once the left and right view sequences, with decimated video data, are generated via the base view encoder 204 and/or enhancement view encoder 206, the left and right sequences may be combined, via the transport multiplexer 208 to generate the transport streams used to communicate, via TV broadcasts and/or multimedia storage devices for example, the 3D video content.

FIG. 4B is a flow chart that illustrates exemplary steps for deinterlacing 3D video, in accordance with an embodiment of the invention. Referring to FIG. 4B, there is shown a flow chart 420 comprising a plurality of exemplary steps that may be performed to enable deinterlacing 3D video.

In step 422, an input video comprising 3D video content with decimated video data may be received by the video processing system 300. In step 424, constituent view sequences in the received 3D video content may be extracted. For example, the transport processor 306 may be operable to extract left and right view video sequences from the input video received via the video processing system 300. In step 426, decimation mode and/or parameters may be determined. In this regard, the decimation mode and/or parameters may describe how the video data may have been decimated, via the video processing system 200 for example, prior to transmittal of video stream comprising the compressed 3D video content. The decimation mode and/or parameters may be determined indirectly, via the receiving device, based on the video data in the received input streams. Alternatively, the decimation mode and/or parameters may be determined directly based on preconfigured data and/or based on data embedded in the received input stream. For example, the video processor 312 may be operable to determine the decimation mode of the extracted left and right view sequence. In this regard, the received 3D video content may be decimated by converting the original view sequences from progressive video to interlaced video. Accordingly, the video processor 312 may determine the manner by which the left and/or right view stream may have been converted to interlaced video. In step 428, missing and/or decimated video data may be reconstructed. For example, the video processor 312 may be operable to deinterlace the extracted left and right view sequences, converting them to progressive video, substantially as described with regard to, for example, FIGS. 3B and 3C. In step 430, output left and right view stream, comprising reconstructed video data, may be generated. For example, the video processor 312 may generate the output left and right view streams 332 and 334 (or 336 and 338), which may then be further processed via the display transform module 314 for 3D playback via the display 320.

Various embodiments of the invention may comprise a method and system for interlacing 3D video. The video processing system 200 may generate and/or capture, via the 3D-video source 202, a plurality of view sequences of video frames. The video processing system 200 may then generate 3D video streams comprising the plurality of view sequences, wherein at least some of the plurality of view sequences may be decimated, via the base view encoder 204 and/or the enhancement view encoder 206, during generation of the 3D video stream. The video processing system 200 may determine, via the transport multiplexer 208 for example, bandwidth limitations existing during direct and/or indirect transfer or communication of the generated 3D video streams. The decimation may be performed based on this determination of bandwidth limitations. The decimation may be achieved by converting one or more of the plurality of view sequences from progressive to interlaced video. The conversion from progressive video to interlaced video may be performed by removing top or bottom fields in each frame of those one or more view sequences during the conversion to interlaced video. The removed fields may be selected, during such interlacing operations, based on corresponding conversion to interlaced video of one or more corresponding view sequences. For example, the plurality of view sequences of video frames may comprise sequences of stereoscopic left and right reference frames. Accordingly, the conversion from progressive video to interlaced video may comprise removing top fields of all frames in the sequence of stereoscopic left reference frames and bottom fields of all frames in the sequence of stereoscopic right reference frames, or bottom fields of all frames in the sequence of stereoscopic left reference frames and top fields of all frames in the sequence of stereoscopic right reference frames. Alternatively, the conversion from progressive video to interlaced video may comprise removing top or bottom fields in the sequences of stereoscopic left and right reference frames, wherein a type of field removed is alternated on frame-by-frame basis within each sequence and is alternated between corresponding frames in the sequences of stereoscopic left and right reference frames. The 3D video streams may be communicated to and/or received by video processing system 300, via the transport processor 306 for example. The video processing system 300 may process received 3D video streams, via the transport processor 306, the video decoder 308, the memory and playback module 310, and/or the video processor 312 for example. The processing of the received 3D video stream may comprise extracting the plurality of view sequences from the received 3D video stream. In instances where the plurality of view sequences may have been subjected to conversion from progressive to interlaced video, the video processing system 300 may deinterlace one or more of the plurality of extracted view sequences determined to comprise interlaced video. The deinterlacing may be performed, via the video processor 312 for example, such that video data for a view sequence, which may have been decimated, may be estimated and/or reconstructed based on processing of corresponding view sequences. The video processing system 300 may then generate 3D video output streams, which may then be further processed and/or adjusted via the display transform module 314, to facilitate video playback via the display 320.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for interlacing 3D video.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for video processing, the method comprising:
performing by one or more processors and/or circuits in a video processing system:
generating a plurality of view sequences of video frames;
decimating one or more of said plurality of view sequences of video frames; and
generating a three-dimension (3D) video stream comprising said plurality of view sequences of video frames based on said decimation.

2. The method according to claim 1, comprising converting said one or more of said plurality of view sequences of video frames to interlaced video to achieve said decimation.

3. The method according to claim 2, comprising removing top or bottom fields in each frame of said one or more of said plurality of view sequences of video frames during said conversion to interlaced video.

4. The method according to claim 3, comprising selecting said removed fields in each of said one or more of said plurality of view sequences of video frames based on corresponding conversion to interlaced video of one or more corresponding view sequences.

5. The method according to claim 1, wherein said plurality of view sequences of video frames comprises sequences of stereoscopic left and right reference frames.

6. The method according to claim 5, comprising removing, during said decimation, top fields of all frames in said sequence of stereoscopic left reference frames and bottom fields of all frames in said sequence of stereoscopic right reference frames, or bottom fields of all frames in said sequence of stereoscopic left reference frames and top fields of all frames in said sequence of stereoscopic right reference frames.

7. The method according to claim 5, comprising removing, during said decimation, top or bottom fields in said sequences of stereoscopic left and right reference frames, wherein a type of field removed is alternated on frame-by-frame basis within each sequence and is alternated between corresponding frames in said sequences of stereoscopic left and right reference frames.

8. The method according to claim 1, comprising determining bandwidth limitations during transfer and/or communication of said generated 3D video stream.

9. The method according to claim 9, comprising performing said decimation based on said determination of bandwidth limitations.

10. The method according to claim 1, wherein said generated 3D video stream is processed by a video processing device, said processing comprising:
extracting said plurality of view sequences from said generated 3D video stream, wherein one or more of said plurality of view sequences comprises interlaced video;
deinterlacing one or more of said plurality of extracted view sequences comprising interlaced video; and
generating a three-dimension (3D) output video from said plurality of extracted view sequences based on said deinterlacing.

11. A system for video processing, the system comprising:
one or more circuits and/or processors in a video processing device that are operable to generate a plurality of view sequences of video frames;
said one or more circuits and/or processors are operable to decimate one or more of said plurality of view sequences of video frames; and
said one or more circuits and/or processors are operable to generate a three-dimension (3D) video stream comprising said plurality of view sequences of video frames based on said decimation.

12. The system according to claim 11, wherein said one or more circuits and/or processors are operable to convert said one or more of said plurality of view sequences of video frames to interlaced video to achieve said decimation.

13. The system according to claim 12, wherein said one or more circuits and/or processors are operable to remove top or bottom fields in each frame of said one or more of said plurality of view sequences of video frames during said conversion to interlaced video.

14. The system according to claim 13, wherein said one or more circuits and/or processors are operable to select said removed fields in each of said one or more of said plurality of view sequences of video frames based on corresponding conversion to interlaced video of one or more corresponding view sequences.

15. The system according to claim 11, wherein said plurality of view sequences of video frames comprises sequences of stereoscopic left and right reference frames.

16. The system according to claim 15, wherein said one or more circuits and/or processors are operable to remove, during said decimation, top fields of all frames in said sequence of stereoscopic left reference frames and bottom fields of all frames in said sequence of stereoscopic right reference frames, or bottom fields of all frames in said sequence of stereoscopic left reference frames and top fields of all frames in said sequence of stereoscopic right reference frames.

17. The system according to claim 15, wherein said one or more circuits and/or processors are operable to remove, during said decimation, top or bottom fields in said sequences of stereoscopic left and right reference frames, wherein a type of field removed is alternated on frame-by-frame basis within each sequence and is alternated between corresponding frames in said sequences of stereoscopic left and right reference frames.

18. The system according to claim 11, wherein said one or more circuits and/or processors are operable to determine bandwidth limitations during transfer and/or communication of said generated 3D video stream.

19. The system according to claim 19, wherein said one or more circuits and/or processors are operable to perform said decimation based on said determination of bandwidth limitations.

20. The system according to claim 11, wherein said generated 3D video stream is processed by a receiving video processing device, said processing comprising:
extracting said plurality of view sequences from said generated 3D video stream, wherein one or more of said plurality of view sequences comprises interlaced video;
deinterlacing one or more of said plurality of extracted view sequences comprising interlaced video; and
generating a three-dimension (3D) output video from said plurality of extracted view sequences based on said deinterlacing.
